(19) United States
(12) Patent Application Publication
(10) Pub. No.: US 2025/0306857 A1
(43) Pub. Date: Oct. 2, 2025

(54) METHOD AND NON-TRANSITORY COMPUTER-READABLE STORAGE MEDIUM AND APPARATUS FOR ACCESSING RANDOMIZED DATA

(71) Applicant: Silicon Motion, Inc., Zhubei City (TW)

(72) Inventor: Fa-Hao LI, Shenzhen City (CN)

(73) Assignee: Silicon Motion, Inc., Zhubei City (TW)

(21) Appl. No.: 19/015,965

(22) Filed: Jan. 10, 2025

(30) Foreign Application Priority Data
Apr. 2, 2024 (CN) 202410396791.8

(51) Int. Cl. G06F 7/58; G06F 7/10

(52) U.S. Cl. CPC G06F 7/588; G06F 7/10

(57) ABSTRACT

The invention introduces a method for accessing randomized data, performed by a processing unit, includes: obtaining user data sets corresponding to one word line from a host side; calculating a randomization seed according to a page number of a specific page on the word line for each user data set; generating a randomized sequence by using a randomization algorithm according to each randomization seed; performing a logical bitwise XOR computation on each user data set and a corresponding randomized sequence to generate a first randomized data set; and programming each first randomized data set into a designated physical address including a corresponding page number on the word line in the flash module.

### CROSS-REFERENCE TO RELATED APPLICATIONS

This application claims the benefit of priority to patent application No. 202410396791.8, filed in China on Apr. 2, 2024; the entirety of which is incorporated herein by reference for all purposes.

### BACKGROUND

The disclosure generally relates to storage devices and, more particularly, to a method, a non-transitory computer-readable storage medium and an apparatus for accessing randomized data.

Flash memory devices typically include NOR flash devices and NAND flash devices. NOR flash devices are random access—a host side accessing a NOR flash device can provide the device any address on its address pins and immediately retrieve data stored in that address on the device's data pins. NAND flash devices, on the other hand, are not random access but serial access. It is not possible for NAND to access any random address in the way described above. Instead, the host side has to write into the device a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word.

However, if the total numbers of logical 0s and logical 1s in user data stored in a flash unit are not balanced, read disturbance would occur when the user data is read, resulting in more read errors. In order to balance the total numbers of logical 0s and logical 1s in the stored user data, embodiments of the present invention provides a method, a non-transitory computer-readable storage medium and an apparatus for accessing randomized data.

### SUMMARY

In an aspect of the invention, an embodiment introduces a method for accessing randomized data, performed by a processing unit, to include the following steps: obtaining user data sets corresponding to one word line from a host side, where the word line is arranged operably to store a plurality of pages of data, and each user data set is to be programmed into one of the pages on the word line; calculating a randomization seed according to a page number of a specific page on the word line for each user data set; generating a randomized sequence by using a randomization algorithm according to each randomization seed; performing a logical bitwise XOR computation on each user data set and a corresponding randomized sequence to generate a first randomized data set; and programming each first randomized data set into a designated physical address comprising a corresponding page number on the word line in the flash module.

In another aspect of the invention, an embodiment introduces a non-transitory computer-readable storage medium having stored therein program code that, when loaded and executed by a processing unit, causes the processing unit to perform the method for accessing randomized data, as described above.

In still another aspect of the invention, an embodiment introduces an apparatus for accessing randomized data, to include: a flash interface (I/F), coupled to a flash module; and a processing unit, coupled to the flash I/F. The processing unit is arranged operably to: obtain user data sets corresponding to one word line from a host side, where the word line is arranged operably to store a plurality of pages of data, and each user data set is to be programmed into one of the pages on the word line; calculate a randomization seed according to a page number of a specific page on the word line for each user data set; generate a randomized sequence by using a randomization algorithm according to each randomization seed; perform a logical bitwise XOR computation on each user data set and a corresponding randomized sequence to generate a first randomized data set; and drive the flash I/F to program each first randomized data set into a designated physical address comprising a corresponding page number on the word line in the flash module.

Both the foregoing general description and the following detailed description are examples and explanatory only, and are not restrictive of the invention as claimed.

### BRIEF DESCRIPTION OF THE DRAWINGS

FIG. 1 is the system architecture of an electronic apparatus according to an embodiment of the present invention.

FIG. 2 is a schematic diagram illustrating a flash module according to an embodiment of the present invention.

FIG. 3 is a schematic diagram showing the hardware architecture of a portion of a NAND flash unit according to an embodiment of the present invention.

FIG. 4 is a data flow diagram for generating randomized data according to an embodiment of the present invention.

FIG. 5 is a data flow diagram for restoring user data according to an embodiment of the present invention.

FIG. 6 is a flowchart illustrating a method for programming randomized data according to an embodiment of the present invention.

FIG. 7 is flowchart illustrating a method for optimizing and programming randomized data according to an embodiment of the present invention.

FIG. 8 is a schematic diagram for generating randomized data according to an embodiment of the present invention.

FIG. 9 is a schematic diagram for changing the order for programming user data sets on a word line according to an embodiment of the present invention.

### DETAILED DESCRIPTION

Reference is made in detail to embodiments of the invention, which are illustrated in the accompanying drawings. The same reference numbers may be used throughout the drawings to refer to the same or like parts, components, or operations.

Certain aspects and embodiments of this disclosure are provided below. Some of these embodiments may be applied independently and some of them may be applied in conjunction as would be apparent to those of skill in the art. In the following description, for the purposes of explanation, specific details are set forth in order to provide a thorough understanding of aspects of the application. However, it will be apparent that various embodiments may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that changes may be made in the function and arrangement of elements without departing from the spirit and scope of the application as set forth in the claims.

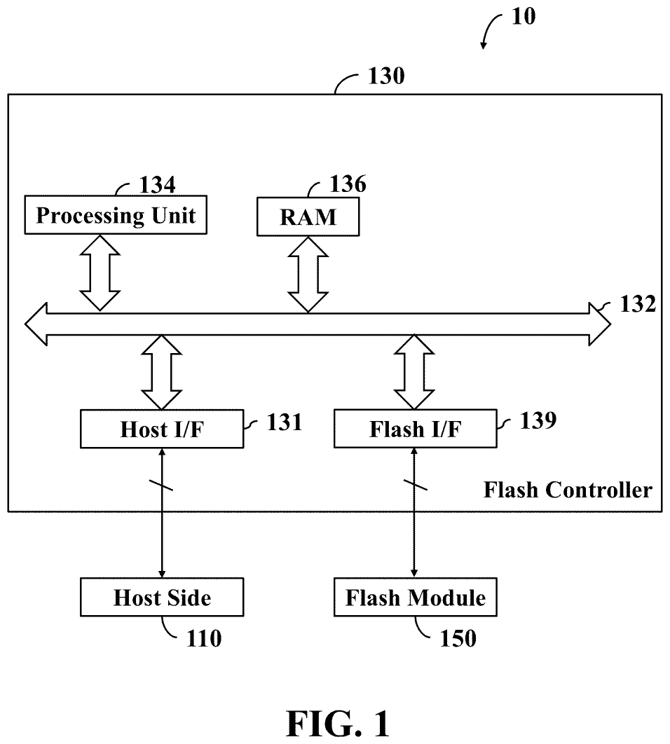

Refer to FIG. 1. The electronic apparatus 10 includes the host side 110, the flash controller 130 and the flash module 150, and the flash controller 130 and the flash module 150 may be collectively referred to as a device side. The electronic apparatus 10 may be equipped with an external storage device, a Personal Computer (PC), a laptop PC, a tablet PC, a mobile phone, a digital camera, a digital recorder, a smart television, a smart freezer, an automotive electronics system or other consumer electronic products. The host side 110 and the host interface (I/F) 131 of the flash controller 130 may communicate with each other by Universal Serial Bus (USB), Advanced Technology Attachment (ATA), Serial Advanced Technology Attachment (SATA), Peripheral Component Interconnect Express (PCI-E), Universal Flash Storage (UFS), Embedded Multi-Media Card (eMMC) protocol, or others. The flash I/F 139 of the flash controller 130 and the flash module 150 may communicate with each other by a Double Data Rate (DDR) protocol, such as Open NAND Flash Interface (ONFI), DDR Toggle, or others. The flash controller 130 includes the processing unit 134 and the processing unit 134 may be implemented in numerous ways, such as with general-purpose hardware (e.g., a microcontroller unit, a single processor, multiple processors or graphics processing units capable of parallel computations, or others) that is programmed using firmware and/or software instructions to perform the functions recited herein. The processing unit 134 may receive host commands from the host side 110 through the host interface (I/F) 131, such as write commands, read commands, discard commands, erase commands, etc., schedule and execute the host commands. The flash controller 130 includes the Random Access Memory (RAM) 136, which may be implemented in a Dynamic Random Access Memory (DRAM), a Static Random Access Memory (SRAM), or the combination thereof, for allocating space as a data buffer storing user data (also referred to as host data) that has been obtained from the host side 110 and is to be programmed into the flash module 150, and that has been read from the flash module 150 and is to be output to the host side 110. The RAM 136 stores necessary data in execution, such as variables, data tables, data abstracts, host-address to flash-address mapping (H2F) tables, flash-address to host-address mapping (F2H) tables, queues, or others. The flash I/F 139 includes a NAND flash controller (NFC) to provide functions that are required to access to the flash module 150, such as a command sequencer, a Low Density Parity Check (LDPC) encoder/decoder, etc.

The flash controller 130 may be equipped with the bus architecture 132 to couple components to each other to transmit data, addresses, control signals, etc. The components include but not limited to the host I/F 131, the processing unit 134, the RAM 136 and the flash I/F 139. A direct memory access (DMA) circuitry of a component moves data between specific components through the bus architecture 132 according to instructions or control signals. For example, a DMA circuitry of the host I/F 131 or the flash I/F 139 may migrate data in a specific data buffer thereof to a specific address of the RAM 136, migrate data in a specific address of the RAM 136 to a specific data buffer thereof, and so on.

The flash module 150 provides huge storage space typically in hundred Gigabytes (GBs), or even several Terabytes (TBs), for storing a wide range of user data, such as high-resolution images, video files, etc. The flash module 150 includes control circuitries and memory arrays containing memory cells, such as being configured as Single Level Cells (SLCs), Multi-Level Cells (MLCs), Triple Level Cells (TLCs), Quad-Level Cells (QLCs), or any combinations thereof. The processing unit 134 programs user data into a designated address (a destination address) of the flash module 150 and reads user data from a designated address (a source address) thereof through the flash I/F 139. The flash I/F 139 may use several electronic signals including a data line, a clock signal line and control signal lines for coordinating the command, address and data transfer with the flash module 150. The data line may be used to transfer commands, addresses, read data and data to be programmed; and the control signal lines may be used to transfer control signals, such as Chip Enable (CE), Address Latch Enable (ALE), Command Latch Enable (CLE), Write Enable (WE), etc.

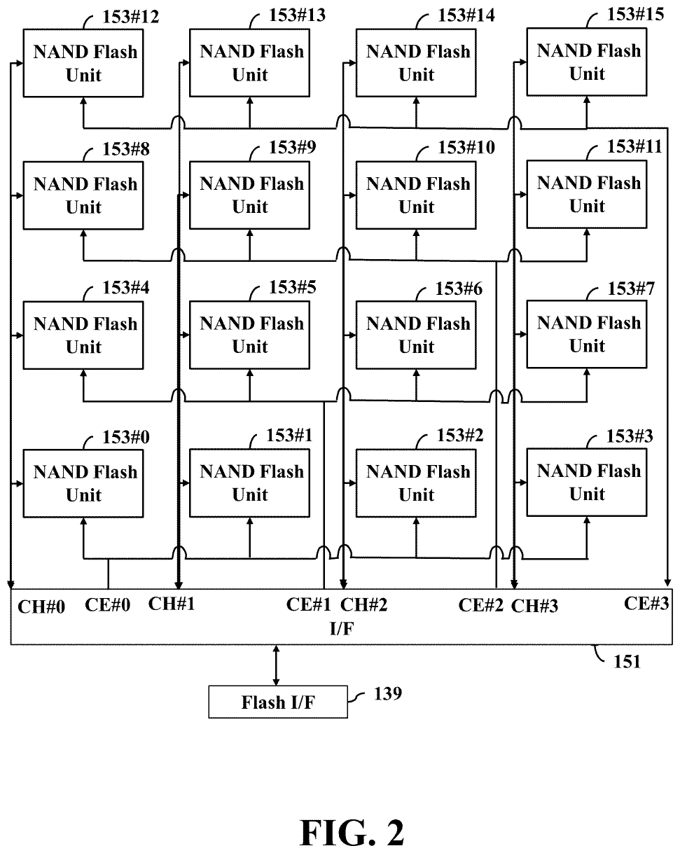

Refer to FIG. 2. The I/F 151 of the flash module 150 may include four I/O channels (hereinafter referred to as channels) CH #0 to CH #3 and each is connected to four NAND flash units, for example, the channel CH #0 is connected to the NAND flash units 150 #0, 150 #4, 150 #8 and 150 #12. Each NAND flash unit can be packaged in an independent die. The flash I/F 139 may issue one of the CE signals CE #0 to CE #3 through the I/F 151 to activate the NAND flash units 153 #0 to 153 #3, the NAND flash units 153 #4 to 153 #7, the NAND flash units 153 #8 to 153 #11, or the NAND flash units 153 #12 to 153 #15, and read data from or program data into the activated NAND flash units in parallel.

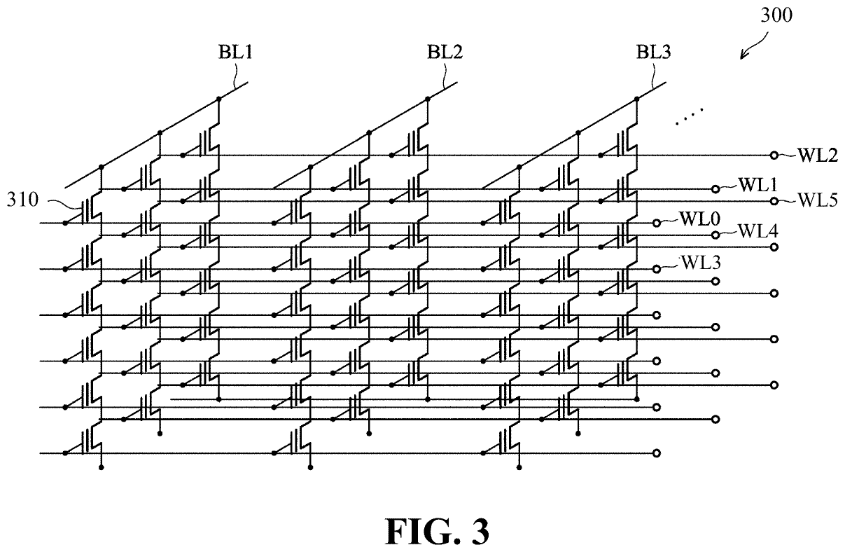

Refer to FIG. 3 showing the hardware architecture of a portion of a NAND flash unit. Each NAND flash unit may contain a plurality of memory blocks (e.g. the memory block 300) and the memory block 300 contains multiple memory cells, such as floating gate transistors (e.g. the floating gate transistor 310), or other charge trap devices. The structure of the memory block 300 includes bit lines and word lines. For brevity, only the bit lines BL1 to BL3 and the word lines WL0 to WL5 are labeled in FIG. 3. For example, the floating gate transistors on the word lines WL0 to WL5 form different pages for storing data.

When each memory cell of a physical block (so-called SLC block) is SLC capable of recording two states, each physical word line stores user data of single pages. When each memory cell of one SB (so-called MLC block) is MLC capable of recording four states, each physical word line stores user data of dual-pages including Most Significant Bit (MSB) pages and Least Significant Bit (LSB) pages. When each memory cell of one SB (so-called TLC block) is TLC capable of recording eight states, each physical word line stores user data of triple-pages, including MSB pages, Center Significant Bit (CSB) pages and LSB pages. When each memory cell of one SB (so-called QLC block) is QLC capable of recording sixteen states, each physical word line stores user data of quad-pages, including Top Significant Bit (TSB) pages, MSB pages, CSB pages and LSB pages.

In order to avoid the read disturbance when user data is read from the flash module 150, the flash controller 130 is configured with a Linear Feedback Shifting Register (LFSR) to store a randomization seed associated with a specific page, and then use a specific randomization algorithm on the randomization seed to generate a randomized sequence. The randomized sequence is subsequently logical bitwise XORed with user data to generate randomized data. Ideally, the total numbers of logical 0s and logical ones in the randomized data is balanced. Then, the flash controller 130 programs the randomized data into a designated page of the flash module 150. In some implementations, specific space of the RAM 136 is allocated for storing the randomization seed table including randomization seeds for one super block (SB). For example, one SB contains 4096 pages, each page stores 16 Kilobyte (16 KB) of user data, and s specific randomization seed in 32 bits is used for each page to generate a randomized sequence. The RAM 136 allocates 16 KB non-volatile space to store all randomization seeds for one SB. The non-volatile space in the RAM 136 is also used to store computer instructions (or program code) of firmware, and system information. However, the non-volatile space in the RAM 136 is a scarce resource, and the randomization seed table would crowd out the storage space for storing the firmware's computer instructions, and the system information. In addition, since the user data received from the host side 110 is unpredictable, although the randomization algorithm is applied with the randomization seeds to the user data, it is not guaranteed that the total numbers of logical 0s and logical 1s in the generated randomized data are balanced.

In order to avoid the randomization seed table occupying scarce non-volatile space in the RAM 136, an embodiment of the present invention introduce a process for generating a randomization seed according to a page number and the length of the generated randomization seed can be 16-bit, 32-bit, 64-bit, etc. For example, the processing unit 134 when executing relevant program code completes equation (1) as follows:

Seed(page)=(page+x)*y
Seed( ) represents the function for generating the randomization seed, * represents the multiplication, page represents the page number, x represents a preset integer constant greater than 0, and y represents a preset integer constant greater than 0. It is noted that those skilled in the art can use other linear equation to generate the 16-bit, 32-bit or 64-bit randomization seed.

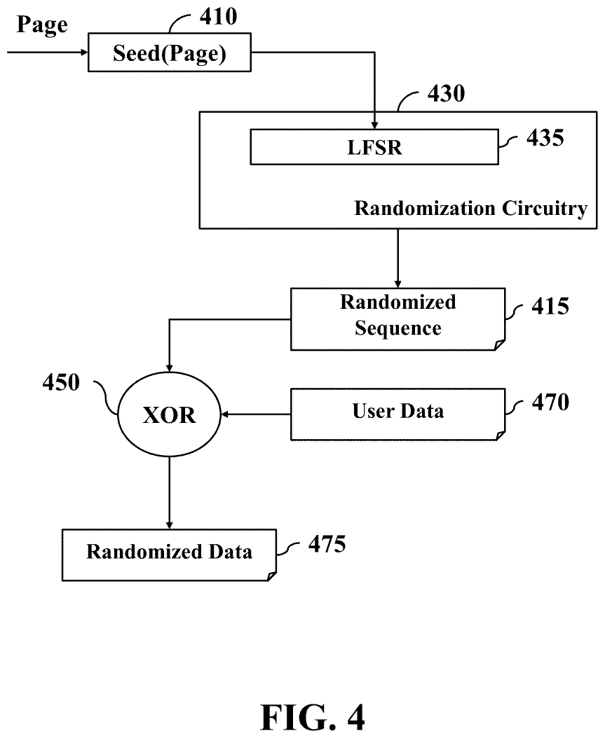

Refer to FIG. 4 showing the data flow diagram for generating randomized data. The generation function 410 obtains the page number “Page” and uses equation (1) to calculate a 32-bit randomization seed according to the page number. In alternative embodiments, the length of the calculated randomization seed may be 16-bit, 64-bit, or others. The flash controller 130 may be equipped with the dedicated randomization circuitry 430 and the randomization circuitry 430 contains the LFSR 435. The generation function 410 stores the generated randomization seed in the LFSR 435. The randomization circuitry 430 is arranged operably to perform a well-known randomization algorithm on the randomization seed in the LFSR 435 to generate the randomized sequence 415. The XOR gates 450 performs the logical bitwise XOR computation on the randomized sequence 415 and the user data 470 to generate the randomized data 475. The lengths of the randomized sequence 415 and the user data 470 are the same, such as, 16 KB. It is noted that the randomization algorithm and the logical bitwise XOR computation can be implemented by computer instructions in software or firmware, which are loaded and executed by the processing unit 134. Subsequently, the processing unit 134 drives the flash I/F 139 to program the randomized data 475 into the physical address including this page number in the flash module 150.

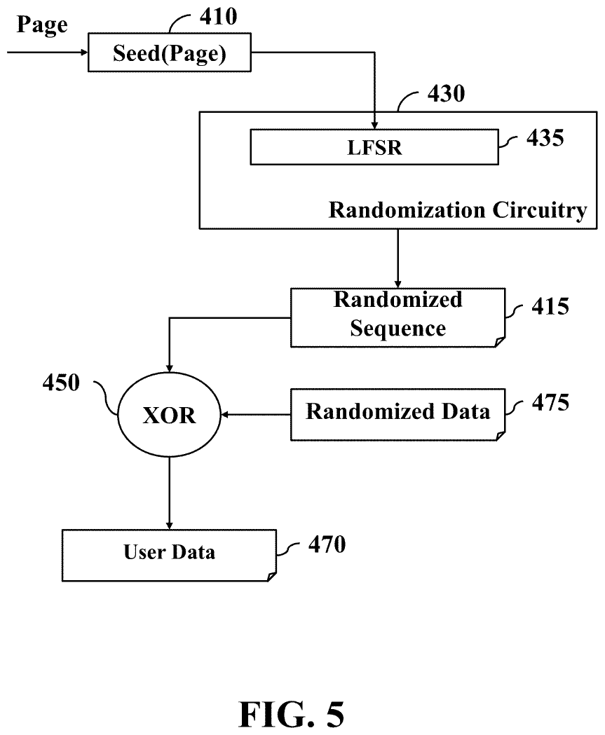

The reverse process is used to restore the user data being read from the flash module 150. Refer to FIG. 5 showing the data flow diagram for restoring user data. The processing unit 134 drives the flash I/F 139 to read the randomized data 475 from the physical address of the flash module 150, where the physical address includes the page number. Since the page number used in the data read process is the same as that is used in the data write process, the randomized sequence 415 generated by the randomization algorithm according to this page number is also the same as that is generated in the data write process. The XOR gates 450 performs the logical bitwise XOR computation on the randomized sequence 415 and the randomized data 475 to restore the user data 470.

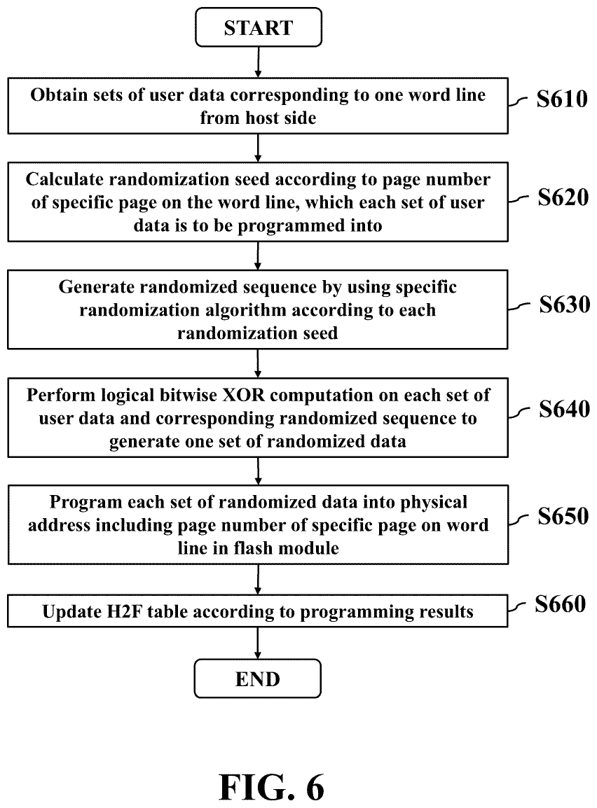

An embodiment of the present invention introduces a method for programming randomized data, which is performed by the processing unit 134 when loading the executing program code of the firmware translation layer (FTL). Refer to FIG. 6 illustrating a flowchart of the method for programming randomized data. The details are as follows:

Step S610: Multiple sets of user data corresponding to one word line is obtained from the host side 110 and each set of user data is planned to program into one page of the word line. If the physical block that user data is to be programmed into is the MLC block, two pages of randomized data are generated for two pages of user data, respectively, for each word line. If the physical block that user data is to be programmed into is the TLC block, three pages of randomized data are generated for three pages of user data, respectively, for each word line. If the physical block that user data is to be programmed into is the QLC block, four pages of randomized data are generated for four pages of user data, respectively, for each word line. The processing unit 134 collects multiple logical block addresses (LBAs) of user data from the host side 110 through the host I/F 131 to form one page of user data that is to be programmed into the flash module 150. The LBA assignment is managed by the host side 110. Assume that one LBA indicates 4 KB of user data and one page in the flash module 150 stores 16 KB of user data: The processing unit 134 collects four LBAs of user data from the host side 110 for each page. For example, the processing unit 134 plans to program the user data of LBA #512-515, LBA #516-519, LBA #520-523 and LBA #524-527 into the TSB page, the MSB page, the CSB page and the LSB page in the QLC block, respectively. The user data of LBA #512-515, LBA #516-519, LBA #520-523 and LBA #524-527 is referred to as four sets of user data.

Step S620: The randomization seed is calculated according to the page number of the specific page on the word line, which each set of user data is to be programmed into.

Step S630: The randomized sequence is generated by using the specific randomization algorithm according to each randomization seed.

Step S640: Each set of user data is logical bitwise XORed with the corresponding randomized sequence to generate one set of randomized data.

Step S650: The flash I/F 139 is driven to program each set of randomized data into the physical address including the page number of the specific page on the word line in the flash module 150.

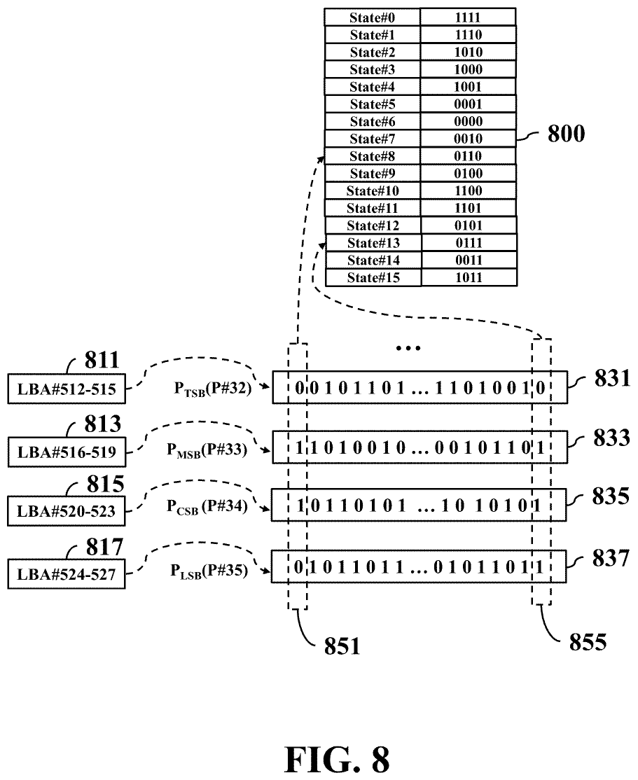

For example, refer to FIG. 8 showing the schematic diagram for generating randomized data. The processing unit 134 plans to store the user data of LBA #512-515, LBA #516-519, LBA #520-523 and LBA #524-527 in the TSB page PTSB (page number is 32), MSB page PMSB (page number is 33), CSB page P_{CSB} (page number is 34) and LSB page P_{LSB} (page number is 35) on the word line in the flash module 150, respectively. The processing unit 134 generates the randomized data 831 for the user data 811 of LBA #512-515 according to the page number “32” of the TSB page, the randomized data 833 for the user data 813 of LBA #516-519 according to the page number “33” of the MSB page, the randomized data 835 for the user data 815 of LBA #520-523 according to the page number “34” of the CSB page and the randomized data 837 for the user data 817 of LBA #524-527 according to the page number “35” of the LSB page through the computation aid of the randomization circuitry 430 and the logical XOR gates 450.

Step S660: The H2F table is updated according to the programming results. The H2F table contains multiple records stored in the order of LBAs. Each record stores mapping information indicating which physical address in the flash module 150 that user data of a specific LBA is physically stored at. The physical address may include such as a SB number, a page number, a section number, etc.

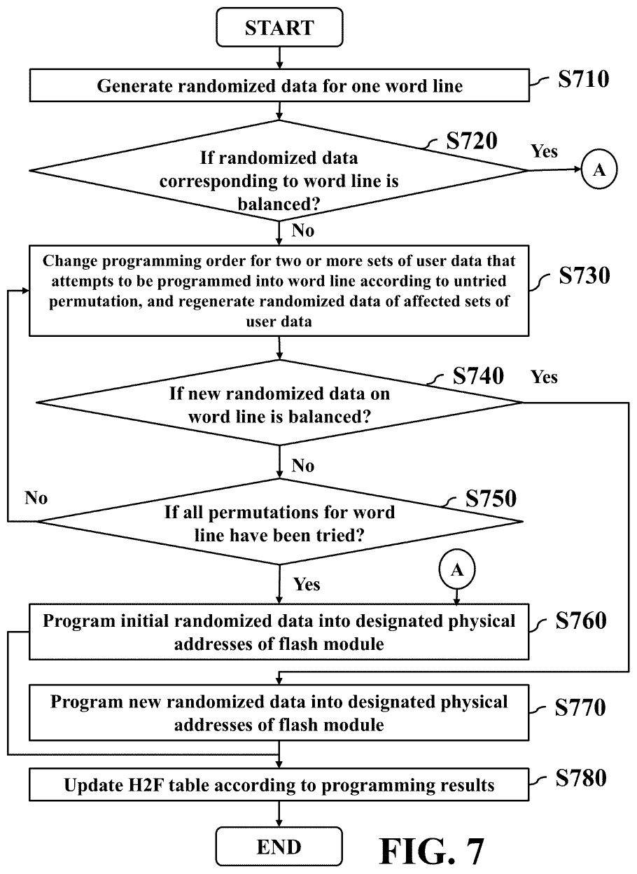

An embodiment of the present invention introduces a process for optimizing the balancing degree of randomized data. The process can be applied in the architecture including the randomization seed table, or the architecture including a method for dynamically generating the randomization seeds according to the page numbers, as shown in FIG. 4. Refer to FIG. 7 illustrating a flowchart of the method for optimizing and programming randomized data. The method is performed by the processing unit 134 of the flash controller 130 when loading and executing program code of the FTL. The details are as follows:

Step S710: Randomized data of multiple page is generated for one word line. For detailed technical content and examples, please refer to steps S610 to S650 in FIG. 6, and the description of FIG. 8. The randomized data sets 831, 833, 835 and 835 are stored in designated addresses in the RAM 136 for subsequent steps to perform balance analysis.

Step S720: It is determined whether the randomized data corresponding to the word line is balanced. If so, the process proceeds to step S760. Otherwise, the process proceeds to step S730.

Step S730: The programming order is changed for two or more sets of user data that attempts to be programmed into the word line according to an untried permutation, and the randomized data of the affected sets of user data are regenerated. Assume that four sets of user data, sequentially labeled as {D0,D1,D2,D3}, that attempts to be programmed into one word line of the QLC block are collected and stored in designated addresses of the RAM 136. The four sets of user data have 24 permutations: {D0,D1,D2,D3}; {D0,D1,D3,D2}; {D0,D2,D1,D3}; {D0,D2,D3,D1}; {D0,D3,D1,D2}; {D0,D3,D2,D1}, etc. The processing unit 134 selects one from untried permutations, and then exchanges two or more sets of user data according to the selected permutation. For example, if the selected permutation is {D0,D1,D3,D2}, then the storage order of the last two sets of user data corresponding to the word line is switched. Since the storage order of the last two sets of user data has been modified, the page numbers in the physical addresses of the flash module 150 for the last two sets of user data that plans to be programmed into the word line are accordingly modified. Subsequently, refer to the description of FIG. 4, randomized data for the affected sets of user data needs to be regenerated.

Step S740: It is determined whether the new randomized data on the word line is balanced. If so, the process proceeds to step S770. Otherwise, the process proceeds to step S750.

Step S750: It is determined whether all permutations for the word line have been tried. If so, the process proceeds to step S760. Otherwise, the process proceeds to step S730.

Step S760: Since all permutations have been tried and no permutation that makes the total numbers of logical 0s and logical 1s in the randomized data approach a balance can be found, the flash I/F 139 is driven to program the randomized data of the pages generated in step S710 into the designated addresses of the flash module 150.

Step S770: Since the permutation that makes the total numbers of logical 0s and logical 1s in the randomized data approach a balance is found, the flash I/F 139 is driven to program the new randomized data of the pages generated in step S730 into the designated addresses of the flash module 150.

Step S780: The H2F table is updated according to the programming results.

Regarding the balance determination in steps S720 and S740, the processing unit 134 analyzes the content of the randomized data sets temporarily stored in the RAM 136 to count a plurality of total amounts for states contained in the randomized data sets. For example, each memory cell in the QLC block records one state among sixteen states. The processing unit 134 calculates the total amounts of the sixteen states contained in the randomized data sets. If one word line of the QLC block contains 131072 or more memory cells, then each page stores 16 KB data and the randomized data contains 131072 or more values. Refer to the exemplary state table 800 as shown in FIG. 8, State #0 indicates “1111”, State #1 indicates “1110”, State #2 indicates “1010”, and so on. The processing unit 134 analyzes the content of the randomized data sets 831, 833, 835 and 837 to count the total amounts of the sixteen states contained in the randomized data sets 831, 833, 835 and 837. For example, the first bits of the randomized data sets 831, 833, 835 and 837 are combined from the TSB, MSC, CSB to LSB pages to form the state “0110” (State #8) 851, the last bits of the randomized data sets 831, 833, 835 and 837 are combined from the TSB, MSC, CSB to LSB pages to form the state “0111” (State #13) 855, and the remaining can be deduced by analogy. The processing unit 134 subsequently determines whether the randomized data generated in step S710 or S730 is balanced according to the statistics results. To determine whether the randomized data is balanced, equations (2) and (3) as shown below can be used:

$${State}_{avg} = PageSize / N$$

$$( {State}_{max} - {State}_{min} ) / {State}_{avg} > Limit$$

State_{avg} represents the theoretical average of each state on the word line, PageSize represents a total number of memory cells on one word line and N represents a total number of states corresponding to a specific physical block. For example, when one word line of the QLC block contains 131072 memory cells, State_{avg} is 131072/16=8192. Stateₘₐₓ represents the total amount of the most counted state, Stateₘᵢₙ represents the total amount of the least counted state, and Limit is a constant greater than 0 and may be set to an arbitrary value ranging from 0.005 to 0.02. When equation (3) does not hold, it means that the generated randomized data is in a balanced state. When equation (3) holds, it means that the generated randomized data is in an unbalanced state. For example, assume that State_{avg} is 8192 and Limit is set to 0.01: If the total amount of the most counted state (e.g. State #0) is 8200 and the total amount of the least counted state (e.g. State #10) is 8180, then 20/8192=0.002 and equation (3) does not hold. If the total amount of the most counted state (e.g. State #0) is 8250 and the total amount of the least counted state (e.g. State #10) is 8050, then 200/8192-0.024 and equation (3) holds.

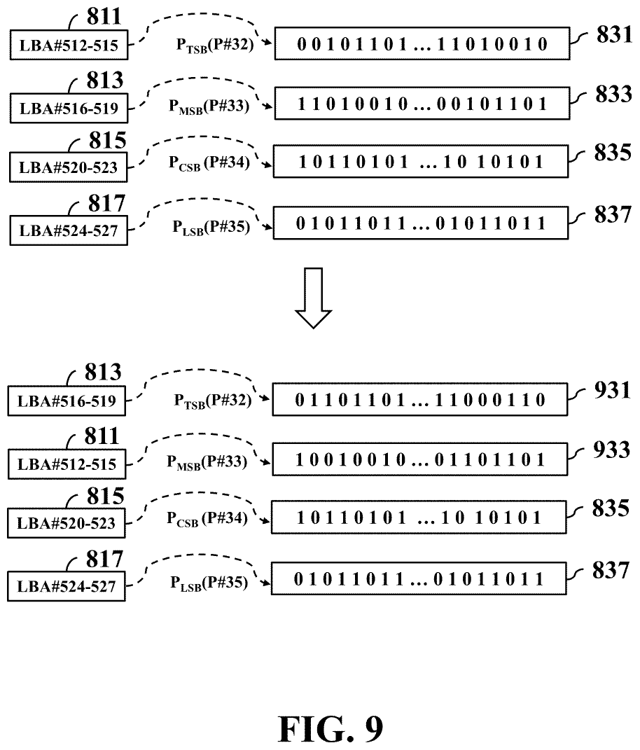

Regarding the adjustment of the programming order in step S730, for example, refer to FIG. 9 showing the schematic diagram for changing the order for programming user data sets on a word line. The user data sets 811, 813, 815 and 817 are sequentially labeled as DO, D1, D2 and D3. As shown in the upper part of FIG. 9, the processing unit 134 initially plans to program the user data sets 811, 813, 815 and 817 in the order {D0,D1,D2,D3} into the TSB page, the MSB page, the CSB page and the LSB page on a designated word line. However, the processing unit 134 discovers that the corresponding randomized data sets 831, 833, 835 and 837 (may be referred to as multiple first randomized data sets) are not balanced. Therefore, in the next iteration of step S730, as shown in the lower part of FIG. 9, the processing unit 134 changes the plan to program the user data sets 813, 811, 815 and 817 in the order {D1, D0,D2,D3} into the TSB page, the MSB page, the CSB page and the LSB page on a designated word line. With the computation aid of the randomization circuitry 430 and the logical XOR gates 450, the processing unit 134 generates the randomized data 931 with the page number “32” of the TSB page for the user data 813 of LBA #516-519 and generates the randomized data 933 with the page number “33” of the MSB page for the user data 811 of LBA #512-515. Subsequently, in the step S740, the processing unit 134 determines whether the total numbers of logical 0s and logical 1s in the newly generated randomized data sets 931, 933, 835 and 837 (may be referred to as multiple second randomized data sets) approaches a balance.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims.

One having ordinary skill in the art will readily understand that the invention as discussed above may be practiced with hardware elements in configurations which are different than those which are disclosed. Therefore, although the invention has been described based upon these preferred embodiments, it would be apparent to those skilled in the art that certain modifications, variations, and alternative constructions would be apparent, while remaining within the scope of the invention.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent.” etc.)

The term “device” or “module” is not limited to one or a specific number of physical objects (such as one smartphone, one controller, one processing system and so on). As used herein, a device may be any electronic device with one or more parts that may implement at least some portions of the invention in this disclosure. While the description and examples use the term “device” or “module” to describe various aspects of this disclosure, the term “device” or “module” is not limited to a specific configuration, type, or number of objects. Additionally, the term “system” or “module” is not limited to multiple components or specific aspects. For example, a system may be implemented on one or more printed circuit boards or other substrates and may have movable or static components. While the description and examples use the term “system” to describe various aspects of the invention in this disclosure, the term “system” is not limited to a specific configuration, type, or number of objects.

Specific details are provided in the description above to provide a thorough understanding of the aspects and examples provided herein. However, it will be understood by one of ordinary skills in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Some or all of the aforementioned embodiments of the method of the invention may be implemented in a computer program such as a driver for a dedicated hardware, a Firmware Translation Layer (FTL) of a storage device, or others. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier, or may be located in a network server accessible via a network such as the Internet, or any other suitable carrier.

A computer-readable storage medium includes volatile and non-volatile, removable and non-removable media implemented in any method or technology for storage of information such as computer-readable instruction, data structures, program modules, or other data. A computer-readable storage medium includes, but is not limited to, RAM, ROM, EEPROM, flash memory or other memory, CD-ROM, digital versatile disks (DVD), Blue-ray disk or other optical storage, magnetic cassettes, magnetic tape, magnetic disk or other magnetic storage devices, or any other medium which can be used to store the desired information and may be accessed by an instruction execution system. Note that a computer-readable medium can be paper or other suitable medium upon which the program is printed, as the program can be electronically captured via, for instance, optical scanning of the paper or other suitable medium, then compiled, interpreted, or otherwise processed in a suitable manner, if necessary, and then stored in a computer memory.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Although the embodiment has been described as having specific elements in FIGS. 1-5, it should be noted that additional elements may be included to achieve better performance without departing from the spirit of the invention. Each element of FIGS. 1-5 is composed of various circuitries and arranged to operably perform the aforementioned operations. While the process flows described in FIGS. 6-7 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for accessing randomized data, performed by a processing unit of a flash controller, wherein the flash controller is coupled to a flash module through a flash interface (I/F) of the flash controller, comprising:
obtaining a plurality of user data sets corresponding to one word line from a host side, wherein the word line is arranged operably to store a plurality of pages of data, and each user data set is to be programmed into one of the pages on the word line;
calculating a randomization seed according to a page number of a specific page on the word line for each user data set;
generating a randomized sequence by using a randomization algorithm according to each randomization seed;
performing a logical bitwise XOR computation on each user data set and a corresponding randomized sequence to generate a first randomized data set; and
programming each first randomized data set into a designated physical address comprising a corresponding page number on the word line in the flash module.

2. The method of claim 1, wherein the randomization seed is calculated by an equation as follows:
$$Seed ( page ) = ( page + x ) * y$$
Seed( ) represents a function for generating the randomization seed, * represents a multiplication, page represents the page number of the specific page, x represents a preset integer constant greater than 0, and y represents a preset integer constant greater than 0.

3. The method of claim 1, comprising:
analyzing content of the first randomized data sets to determine whether the first randomized data sets are balanced; and
programming each first randomized data set into the designated physical address comprising the corresponding page number on the word line in the flash module in response to the first randomized data sets being balanced.

4. The method of claim 3, comprising:
counting a plurality of total amounts for a plurality of states comprised in the first randomized data sets; and
determining whether the first randomized data sets are balanced by using equations as follows:
$${State}_{avg} = PageSize / N$$
$$( {State}_{max} - {State}_{min} ) / {State}_{avg} > Limit$$
wherein State_{avg} represents a theoretical average of each state on the word line, PageSize represents a total number of memory cells on the word line, N represents a total number of states corresponding to a specific physical block, Stateₘₐₓ represents a total amount of a most counted state, Stateₘᵢₙ represents a total amount of a least counted state, Limit is a constant set to an arbitrary value ranging from 0.005 to 0.02,
wherein the first randomized data sets are balanced when (Stateₘₐₓ−Stateₘᵢₙ)/State_{avg} is not greater than Limit.

5. The method of claim 4, wherein Limit is set to 0.01.

6. The method of claim 3, comprising:
in response to the first randomized data sets being unbalanced, repeatedly changing a programming order that plans to program the user data sets into the pages on the word line according to one of a plurality of permutations of the user data sets, and accordingly generating a plurality of second randomized data sets until the second randomized data sets are balanced, or all permutations of the user data sets have been tried; and
programming each second randomized data set into the designated physical address comprising the corresponding page number on the word line in the flash module in response to the second randomized data sets being balanced.

7. The method of claim 6, comprising:
programming each first randomized data set into the designated physical address comprising the corresponding page number on the word line in the flash module in response to all permutations of the user data sets have been tried.

8. A non-transitory computer-readable storage medium having stored therein program code that, when loaded and executed by a processing unit of a flash controller, wherein the flash controller is coupled to a flash module through a flash interface (I/F) of the flash controller, causes the processing unit to:
obtain a plurality of user data set corresponding to one word line from a host side, wherein the word line is arranged operably to store a plurality of pages of data, and each user data set is to be programmed into one of the pages on the word line;
calculate a randomization seed according to a page number of a specific page on the word line for each user data set;
generate a randomized sequence by using a randomization algorithm according to each randomization seed;
perform a logical bitwise XOR computation on each user data set and a corresponding randomized sequence to generate a first randomized data set; and
program each first randomized data set into a designated physical address comprising a corresponding page number on the word line in the flash module.

9. The non-transitory computer-readable storage medium of claim 8, wherein the program code that, when loaded and executed by the processing unit, causes the processing unit to:
Seed(page)=(page+x)*y
Seed( ) represents a function for generating the randomization seed, * represents a multiplication, page represents the page number of the specific page, x represents a preset integer constant greater than 0, and y represents a preset integer constant greater than 0.

10. The non-transitory computer-readable storage medium of claim 8, wherein the program code that, when loaded and executed by the processing unit, causes the processing unit to:
analyze content of the first randomized data sets to determine whether the first randomized data sets are balanced; and
program each first randomized data set into the designated physical address comprising the corresponding page number on the word line in the flash module in response to the first randomized data sets being balanced.

11. The non-transitory computer-readable storage medium of claim 10, wherein the program code that, when loaded and executed by the processing unit, causes the processing unit to:
count a plurality of total amounts for a plurality of states comprised in the first randomized data sets; and
determine whether the first randomized data sets are balanced by using equations as follows,
$${State}_{avg} = PageSize / N$$
$$( {State}_{max} - {State}_{min} ) / {State}_{avg} > Limit$$
wherein State_{avg} represents a theoretical average of each state on the word line, PageSize represents a total number of memory cells on the word line, N represents a total number of states corresponding to a specific physical block, Stateₘₐₓ represents a total amount of a most counted state, Stateₘᵢₙ represents a total amount of a least counted state, Limit is a constant set to 0.01,
wherein the first randomized data sets are balanced when (Stateₘₐₓ−Stateₘᵢₙ)/State_{avg} is not greater than Limit.

12. The non-transitory computer-readable storage medium of claim 10, wherein the program code that, when loaded and executed by the processing unit, causes the processing unit to:
in response to the first randomized data sets being unbalanced, repeatedly change a programming order that plans to program the user data sets into the pages on the word line according to one of a plurality of permutations of the user data sets, and accordingly generate a plurality of second randomized data sets until the second randomized data sets are balanced, or all permutations of the user data sets have been tried; and
program each second randomized data set into the designated physical address comprising the corresponding page number on the word line in the flash module in response to the second randomized data sets being balanced.

13. The non-transitory computer-readable storage medium of claim 12, wherein the program code that, when loaded and executed by the processing unit, causes the processing unit to:
program each first randomized data set into the designated physical address comprising the corresponding page number on the word line in the flash module in response to all permutations of the user data sets have been tried.

14. An apparatus for accessing randomized data, comprising:
a flash interface (I/F), coupled to a flash module; and
a processing unit, coupled to the flash I/F, arranged operably to: obtain a plurality of user data sets corresponding to one word line from a host side, wherein the word line is arranged operably to store a plurality of pages of data, and each user data set is to be programmed into one of the pages on the word line; calculate a randomization seed according to a page number of a specific page on the word line for each user data set; generate a randomized sequence by using a randomization algorithm according to each randomization seed;
perform a logical bitwise XOR computation on each user data set and a corresponding randomized sequence to generate a first randomized data set; and drive the flash I/F to program each first randomized data set into a designated physical address comprising a corresponding page number on the word line in the flash module.

15. The apparatus of claim 14, wherein the randomization seed is calculated by an equation as follows:
Seed(page)=(page+x)*y
Seed( ) represents a function for generating the randomization seed, * represents a multiplication, page represents the page number of the specific page, x represents a preset integer constant greater than 0, and y represents a preset integer constant greater than 0.

16. The apparatus of claim 14, wherein the processing unit is arranged operably to: analyze content of the first randomized data sets to determine whether the first randomized data sets are balanced; and program each first randomized data set into the designated physical address comprising the corresponding page number on the word line in the flash module in response to the first randomized data sets being balanced.

17. The apparatus of claim 16, wherein the processing unit is arranged operably to: count a plurality of total amounts for a plurality of states comprised in the first randomized data sets; and determine whether the first randomized data sets are balanced by using equations as follows:
$${State}_{avg} = PageSize / N$$
$$( {State}_{max} - {State}_{min} ) / {State}_{avg} > Limit$$
wherein State_{avg} represents a theoretical average of each state on the word line, PageSize represents a total number of memory cells on the word line, N represents a total number of states corresponding to a specific physical block, Stateₘₐₓ represents a total amount of a most counted state, Stateₘᵢₙ represents a total amount of a least counted state, Limit is a constant set to an arbitrary value ranging from 0.005 to 0.02,
wherein the first randomized data sets are balanced when (Stateₘₐₓ−Stateₘᵢₙ)/State_{avg} is not greater than Limit.

18. The apparatus of claim 17, wherein Limit is set to 0.01.

19. The apparatus of claim 16, wherein the processing unit is arranged operably to: in response to the first randomized data sets being unbalanced, repeatedly change a programming order that plans to program the user data sets into the pages on the word line according to one of a plurality of permutations of the user data sets, and accordingly generate a plurality of second randomized data sets until the second randomized data sets are balanced, or all permutations of the user data sets have been tried; and drive the flash I/F to program each second randomized data set into the designated physical address comprising the corresponding page number on the word line in the flash module in response to the second randomized data sets being balanced.

20. The apparatus of claim 19, wherein the processing unit is arranged operably to: drive the flash I/F to program each first randomized data set into the designated physical address comprising the corresponding page number on the word line in the flash module in response to all permutations of the user data sets have been tried.
